(19) United States
(12) Patent Application Publication
(10) Pub. No.: US 2021/0350722 A1
(43) Pub. Date: Nov. 11, 2021

(54) SYSTEM AND METHOD FOR AN INTERACTIVE LANGUAGE LEARNING PLATFORM

(71) Applicant: ROSETTA STONE LLC, Harrisonburg, VA (US)

(72) Inventors: Mustafa Muwwakkil, Harrisonburg, VA (US); Faith GOH, Harrisonburg, VA (US); Alan OKADA, Harrisonburg, VA (US)

(21) Appl. No.: 17/308,402

(22) Filed: May 5, 2021

Related U.S. Application Data
(60) Provisional application No. 63/021,575, filed on May 7, 2020.

(51) Int. Cl. G09B 19/06; G09B 5/06; G09B 5/14; G10L 15/00

(52) U.S. Cl. CPC G09B 19/06; G10L 15/005; G09B 5/14; G09B 5/065

(57) ABSTRACT

A language learning platform is provided that includes a user interface and a speech recognition engine. A video repository stores and uploads a plurality of interactive videos to assist a language learner in learning a non-native language. Each of the interactive videos includes a plurality of challenges to be performed by the language learner where the speech recognition engine determines whether the language learner is successful in performing at least one of the challenges. A coaching tool provides the language learner access to one or more lectures, one or more group sessions, or personalized coaching through the user interface to assist the language learner in learning the non-native language. The coaching tool utilizes one or more facilitators/coaches to interact with the language learner to learn the non-native language, and the one or more facilitators/coaches use the speech recognition tool to provide real-time assessment of the language learner's progress.

### RELATED APPLICATIONS

This application claims priority to U.S. provisional application No. 63/021,575 filed on May 7, 2020, the contents of which is included herein in its entirety.

### BACKGROUND

Traditional methods for learning a language, in particular a foreign language, are typically not enjoyable for students. Students may spend most of the time learning rules of grammar and syntax and memorizing words in the target language (the language being learned). The students are generally not exposed to correct pronunciation except for a recording of the target language.

### BRIEF SUMMARY

According to one aspect of the subject matter described in this disclosure, a language learning platform is provided. The language learning platform includes a user interface and a speech recognition engine. A video repository is configured to store and upload a plurality of interactive videos to assist a language learner in learning a non-native language. Each of the interactive videos includes a plurality of challenges to be performed by the language learner where the speech recognition engine evaluates whether the language learner is successful in performing at least one of the challenges. A coaching tool is configured to provide the language learner access to lectures, one or more group sessions, or personalized coaching through the user interface to assist the language learner in learning the non-native language. The coaching tool utilizes one or more facilitators/coaches to interact with the language learner to learn the non-native language, and the one or more facilitators/coaches use the speech recognition tool to provide real-time assessment of the language learner's progress.

According to another aspect of the subject matter described in this disclosure, a method of learning a new language using a language platform is provided. The method includes the following: providing, using one or more computing device processors, a user interface; incorporating, using the one or more computing device processors, a speech recognition engine in the user interface; storing, using the one or more computing device processors, and uploading a plurality of interactive videos to assist a language learner in learning a non-native language; performing, using the one or more computing device processors, a plurality of challenges by the language learner by leveraging each of the interactive videos; determining, using the one or more computing device processors, whether the language learner is successful in performing at least one of the challenges; allowing, using the one or more computing device processors, the language learner to access one or more lectures, one or more group sessions, or personalized coaching through the user interface to assist the language learner in learning the non-native language; implementing, using the one or more computing device processors, interactions between the language learner and one or more facilitators/coaches to assist the language learner in learning the non-native language via the user interface; and providing, using the one or more computing device processors, real-time assessment of the language learner's progress in learning the non-native language.

According to another aspect of the subject matter described in this disclosure, a method of learning a new language using a language platform is provided. The method includes the following: providing, using one or more computing device processors, a user interface; incorporating, using the one or more computing device processors, a speech recognition engine in the user interface; storing, using the one or more computing device processors, and uploading a plurality of interactive videos to assist a language learner in learning a non-native language; performing, using the one or more computing device processors, a plurality of challenges by the language learner by leveraging each of the interactive videos; determining, using the one or more computing device processors, whether the language learner is successful in performing at least one of the challenges; and providing, using the one or more computing device processors, real-time assessment of the language learner's progress in learning the non-native language.

Additional features and advantages of the present invention are described in, and will be apparent from, the detailed description of this disclosure.

### BRIEF DESCRIPTION OF THE DRAWINGS

The disclosure is illustrated by way of example, and not by way of limitation, in the figures of the accompanying drawings in which like reference numerals are used to refer to similar elements. It is emphasized that various features may not be drawn to scale and the dimensions of various features may be arbitrarily increased or reduced for clarity of discussion.

FIG. 1 is a schematic diagram illustrating a general overview of a language learning platform, in accordance with some embodiments.

FIG. 2 is a schematic diagram illustrating an example of an interactive video, in accordance with some embodiments.

FIG. 3 is a schematic diagram illustrating an example of what occurs when a challenge 300 is accepted, in accordance with some embodiments.

FIG. 4 is a flowchart illustrating a method for submitting data in a computer network, in accordance with some embodiments.

FIG. 5 is a schematic diagram illustrating an example computing system with carrying out some of the methods of the present disclosure, in accordance with some embodiments.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context.

Quite often, a language learner interacts with a language learning application by repeating phrases in a non-native language. Afterwards, the language learning application analyzes the utterances spoken by the language learner, and provides feedback on his/her performance. Often a language learner's interaction with a language learning application can be limited. This occurs because many language learning applications are not implemented on platforms that leverage interactive learning.

Thus, it may be desirable to develop a language learning platform that improves user interaction. This may allow the user to better utilize the language learning platform to increase the proficiency in learning a non-native language. The present disclosure is directed to an improved language learning platform that provides video interactivity and coaching tools to further assist language learners. The language learning platform includes a speech recognition engine (SRE) that is incorporated in both the interactive videos and the coaching tools allowing for real time assessment of a learner's progress.

An exemplary benefit or advantage of the present disclosure is an improved language learning platform that offers enhanced interactive capabilities and additional coaching services by leveraging an SRE. For example, with the techniques in the present disclosure, a language learner can learn a non-native language by accessing interactive videos through the language learning platform. The interactive videos include integrated speech practice activities dispersed throughout. The SRE is used to assess the progress of the language learner. Also, the language learner can access a live coaching tool for tutoring, personalized learning, or to attend lectures on learning a non-native language. The coaching tool also leverages the SRE to assess a language learner's progress.

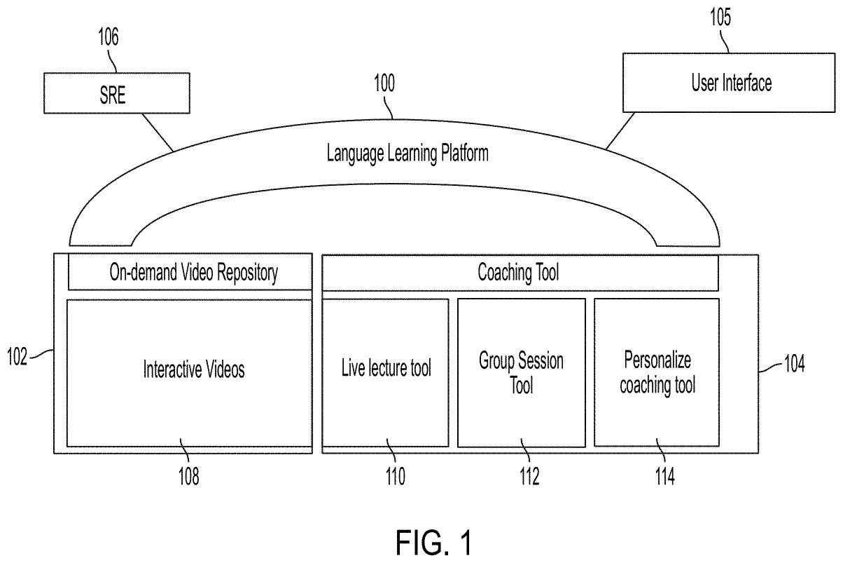

FIG. 1 is a schematic diagram illustrating a general overview of a language learning platform 100, in accordance with some embodiments. Language learning platform 100 includes an on-demand video repository 102, a coaching tool 104, and a speech recognition engine (SRE) 106. SRE 106 is utilized by the learning language platform 100 to actively assess the performance of the language learners as they interact with language learning platform 100. A language learner can access language learning platform 100 either through an authentication process, access code, or the like. Once authorized to use language learning platform 100, the language learner can access on-demand video repository 102 or coaching tool 104. The language learner interacts with language learning platform 100 through user interface 105. User interface 105 can reside on a local client machine/mobile device or can be downloaded to the local client machine/mobile device from a server where the learning language platform 100 resides.

On-demand video repository 102 is a data repository storing a collection of interactive videos 106 the language learner can use to learn a non-native language. Interactive videos 106 are designed by experts covering themes including common scenarios, pronunciation, grammar and the like. User interface 105 allows the language learner to interact, access and watch interactive videos 108. Moreover, each of the interactive videos 108 include integrated speech practice activities dispersed throughout. SRE 106 is used to assess the performance of the language learner as they progress through the speech practice activities. This involves user interface 105 actively managing the audio input devices that the language learner uses to perform the speech practice activities. In some embodiments, the audio input devices can include speakerphones, headsets, or the like. In some embodiments, interactive videos 106 are streamed on a language learner's local client system/mobile device. In some embodiments, interactive videos 106 are downloaded directly to a language learner's local client system/mobile device.

Language learning platform 100 offers the language learner alternatives in learning a non-native language. Besides learning from interactive videos 108, the language learner can use coaching tool 104 to increase interactions in learning a non-native language with others. Coaching tool 104 provides a medium where live facilitator(s)/coach(es) can interact with one or more language learners. Moreover, coaching tool 104 can aid those language learners who are having difficulties with personalized one-on-one coaching or tutoring.

Coaching tool 104 includes a live lecture tool 110, a group session tool 112, and a personalized coaching tool 114. Each of the live lecture tool 110, group session tool 112, and personalized coaching tool 114 utilizes user interface 105 to offer audio and visual capabilities needed by language learners to see and hear their facilitator(s)/coach(es) as well as other language learners if needed. Moreover, coaching tool 104 incorporates SRE 106, which provides facilitator(s)/coach(es) the capability to assess the progress of one or more language learners in real-time. Also, language learners can also see for themselves in real-time their progress while interacting with their respective facilitator(s)/coach(es).

Live lecture tool 110 broadcasts live lecture sessions accessible to all language learners. During a live lecture session, language learners can see a facilitator(s)/coach(es) lecture about learning a non-native language. Also, live lecture tool 110 allows chatting between language learners including the facilitator(s)/coach(es) during lecture. Polling and voting is permitted amongst the language learners as well. In addition, lecture tool 110 allows for SRE-based interactive activities. This can include facilitator(s)/coach(es) pushing out SRE-based activities mid-session to have the language learners do speech practice. The facilitator(s)/coach(es) have access to the individual language learner SRE results in the live lecture session to provide encouragement and assessment. In some embodiments, live lecture tool 110 allows the facilitator(s)/coach(es) to see other language learners live. The integration of SRE activities into the group session allows for direct interaction with a facilitator/coach, thus providing a user experience of a 1:1 class, even though the facilitator/coach may be working with a large number of language learners.

Group session tool 112 provides a live group session where one facilitator/coach works with a number of language learners, such as 2-4 language learners. The live group session can be associated with coursework from a lecture or other language course offerings. The limited number of language learners in a group session allows for role playing to be utilized, where language learners can practice pronunciation with inline SRE activities tied to their role play. Moreover, the facilitator/coach can push other inline SRE activities mid-session to have the language learners do speech practice. The facilitator/coach has access to the individual language learner SRE results in the live group session to provide encouragement and assessment.

Personalized coaching tool 114 provides a live personalized session where a facilitator/coach works with a single learner. The live personalized session can be associated with coursework from a lecture or other language course offerings. Since there is only a single language learner, a personalized session allows for role playing to be utilized, where the language learner can practice pronunciation with inline SRE activities tied to their role play. In addition, the facilitator/coach can customize for the language learner personalized learning objectives to help a language learner who is having difficulty mastering a non-native language using inline SRE activities to assess the progress of the language learner. Moreover, the facilitator/coach can push other inline SRE activities mid-session to have the language learners do speech practice, then re-join the session. The facilitator/coach has access to the language learner's SRE results in the live personalized session to provide encouragement and assessment.

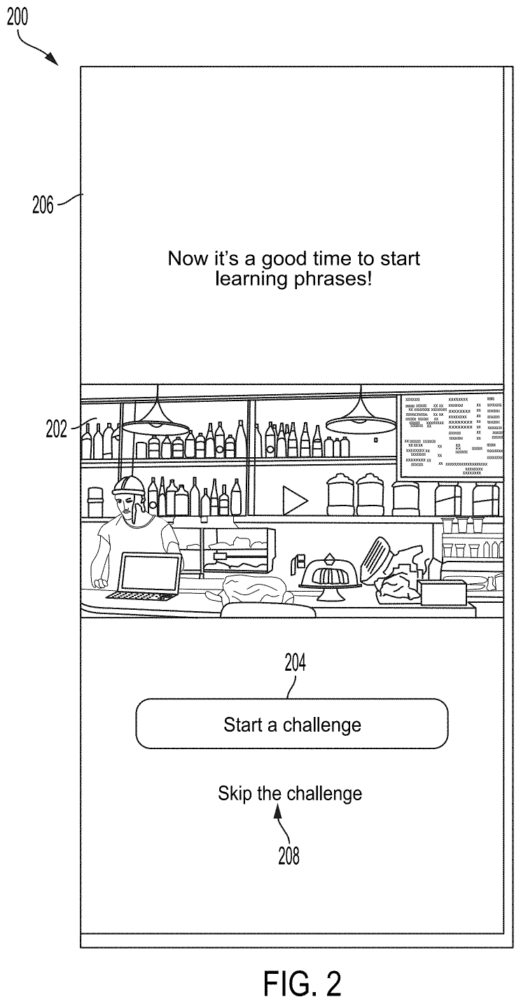

FIG. 2 depicts an example of an interactive video 200, in accordance with some embodiments. Interactive video 200 includes a video portion 202, a challenge button 204, and a user interface 206 that allows a language learner to see and interact with interactive video 200. At moments throughout the interactive video 200 language learners will be presented with a number of challenges. The language learner clicks the challenge button 204 to start a challenge. Otherwise, the language learner can skip a challenge by clicking link 208.

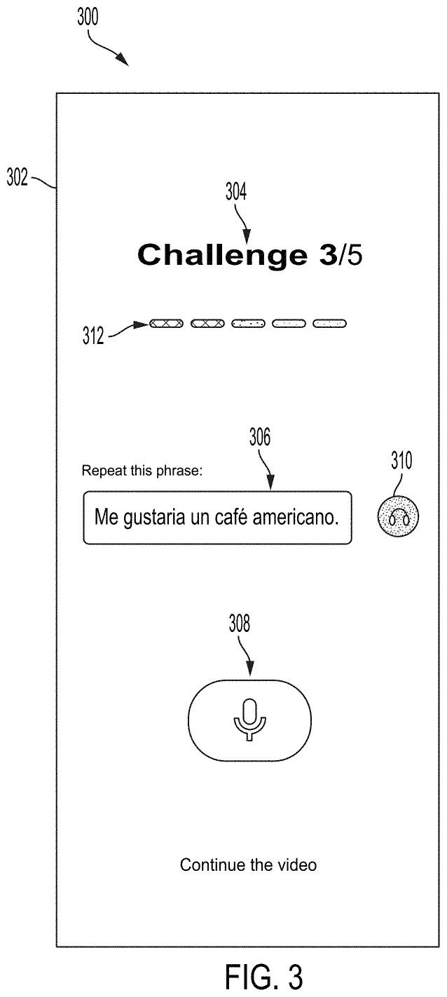

FIG. 3 depicts an example of what occurs when a challenge 300 is accepted, in accordance with some embodiments. Challenge 300 is displayed in user interface 302, which includes a challenge number 304, a phrase 306, voice button 308, an assistance button 310, and status indicator 312. Challenge number 304 indicates a specific challenge being provided by an interactive video. In this case, the challenge number 304 is associated with the third challenge in the interactive video. Note this interactive video has 5 total challenges. Each challenge 304 includes phrase 306 that was explained in a previous video segment, which in this case is “Me gustaria un cafe americano.” The language learner clicks voice button 308 to activate an audio input device and repeats the phrase 306 to the audio input device. An SRE receives the utterances of phrase 306 sent by the audio input device. If the SRE determines the language learner was successful in the challenge, status indicator 312 related to the challenge number 304 will indicate a color green. Otherwise, status indicator 312 will indicate a color red if a challenge was not successful. When a language learner needs assistance in hearing phrase 306 in the video segment, language learner can click assistance button 310 to hear an audio replay of the phrase in the video segment.

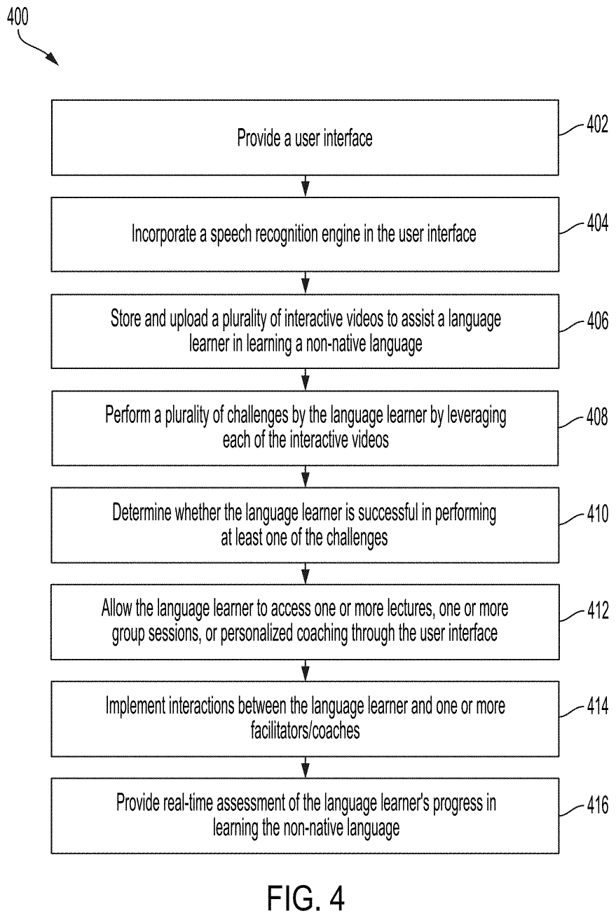

FIG. 4 show flowchart 400 illustrating a method for submitting data in a computer network, in accordance with some embodiments. In block 402, the method includes providing, using one or more computing device processors, a user interface. At block 404, the method includes incorporating, using the one or more computing device processors, a speech recognition engine in the user interface. At block 406, the method includes storing, using the one or more computing device processors, and uploading a plurality of interactive videos to assist a language learner in learning a non-native language. At block 408, the method includes performing, using the one or more computing device processors, a plurality of challenges by the language learner by leveraging each of the interactive videos.

At block 410, the method includes evaluating, using the one or more computing device processors, whether the language learner is successful in performing at least one of the challenges. The method includes allowing, using the one or more computing device processors, the language learner to access one or more lectures, one or more group sessions, or personalized coaching through the user interface to assist the language learner in learning the non-native language, as shown at block 412. Also, the method includes implementing, using the one or more computing device processors, interactions between the language learner and one or more facilitators/coaches to assist the language learner in learning the non-native language via the user interface, as shown at block 414. At block 416, the method includes providing, using the one or more computing device processors, real-time assessment of the language learner's progress in learning the non-native language.

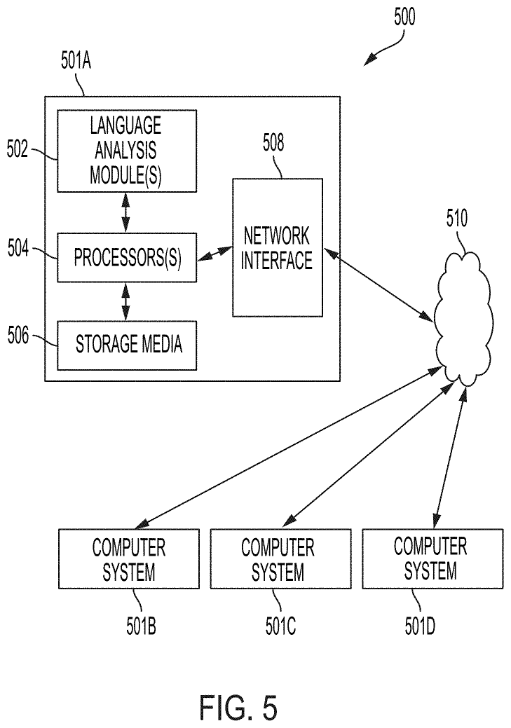

FIG. 5 depicts an example computing system 500 with carrying out some of the methods of the present disclosure, in accordance with some embodiments. For example, the computing system 500 may perform the workflow 400 including language platform 100 described herein.

The computing system 500 can be an individual computer system 501A or an arrangement of distributed computer systems. The computer system 501A includes one or more language analysis modules 502 that are configured to perform various tasks according to some embodiments, such as one or more methods disclosed herein. To perform these various tasks, language analysis module 502 executes independently, or in coordination with, one or more processors 504, which is (or are) connected to one or more storage media 506. The processor(s) 504 is (or are) also connected to a network interface 508 to allow the computer system 501A to communicate over a data network 510 with one or more additional computer systems and/or computing systems, such as 501B, 501C, and/or 501D (note that computer systems 501B, 501C and/or 501D may or may not share the same architecture as computer system 501A, and may be located in different physical locations. Note that data network 510 may be a private network, it may use portions of public networks, it may include remote storage and/or applications processing capabilities (e.g., cloud computing).

A processor can include a microprocessor, microcontroller, processor module or subsystem, programmable integrated circuit, programmable gate array, or another control or computing device.

The storage media 506 can be implemented as one or more computer-readable or machine-readable storage media. Note that while in the example embodiment of FIG. 5 storage media 506 is depicted as within computer system 501A, in some embodiments, storage media 506 may be distributed within and/or across multiple internal and/or external enclosures of computing system 501A and/or additional computing systems. Storage media 506 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. “Non-transitory” computer readable medium refers to the medium itself (i.e., tangible, not a signal) and not data storage persistency (e.g., RAM vs. ROM).

Note that the instructions or methods discussed above can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions or located at a remote site from which machine-readable instructions can be downloaded over a network for execution.

It should be appreciated that computer system 501A is one example of a computing system, and that computer system 501A may have more or fewer components than shown, may combine additional components not depicted in the example embodiment of FIG. 5, and/or computer system 501A may have a different configuration or arrangement of the components depicted in FIG. 5. The various components shown in FIG. 5 may be implemented in hardware, software, or a combination of both, hardware and software, including one or more signal processing and/or application specific integrated circuits.

It should also be appreciated that while no user input/output peripherals are illustrated with respect to computer systems 501A, 501B, 501C, and 501D, many embodiments of computing system 500 include computing systems with keyboards, touch screens, displays, etc. Some computing systems in use in computing system 500 may be desktop workstations, laptops, tablet computers, smartphones, server computers, etc.

Further, the steps in the processing methods described herein may be implemented by running one or more functional modules in information processing apparatus such as general-purpose processors or application specific chips, such as ASICs, FPGAs, PLDs, or other appropriate devices. These modules, combinations of these modules, and/or their combination with general hardware are included within the scope of protection of the disclosure.

In some embodiments, a computing system is provided that comprises at least one processor, at least one memory, and one or more programs stored in the at least one memory, wherein the programs comprise instructions, which when executed by the at least one processor, are configured to perform any method disclosed herein.

In some embodiments, a computer readable storage medium is provided, which has stored therein one or more programs, the one or more programs comprising instructions, which when executed by a processor, cause the processor to perform any method disclosed herein.

In some embodiments, a computing system is provided that comprises at least one processor, at least one memory, and one or more programs stored in the at least one memory; and means for performing any method disclosed herein.

In some embodiments, an information processing apparatus for use in a computing system is provided, and that includes means for performing any method disclosed herein.

In some embodiments, a graphics processing unit is provided, and that includes means for performing any method disclosed herein.

Reference in the specification to “one implementation” or “an implementation” means that a particular feature, structure, or characteristic described in connection with the implementation is included in at least one implementation of the disclosure. The appearances of the phrase “in one implementation,” “in some implementations,” “in one instance,” “in some instances,” “in one case,” “in some cases,” “in one embodiment,” or “in some embodiments” in various places in the specification are not necessarily all referring to the same implementation or embodiment.

Finally, the above descriptions of the implementations of the present disclosure have been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As will be understood by those familiar with the art, the present disclosure may be embodied in other specific forms without departing from the spirit or essential characteristics thereof. Accordingly, the present disclosure is intended to be illustrative, but not limiting, of the scope of the present disclosure, which is set forth in the following claims.

What is claimed is:

1. A language learning platform, comprising:
a user interface;
a speech recognition engine;
a video repository accessible through the user interface, the video repository being configured to store and upload a plurality of interactive videos to assist a language learner in learning a non-native language, wherein each of the interactive videos includes a plurality of challenges to be performed by the language learner where the speech recognition engine determines whether the language learner is successful in performing at least one of the challenges; and
a coaching tool configured to provide the language learner access to one or more lectures, one or more group sessions, or personalized coaching through the user interface to assist the language learner in learning the non-native language, wherein the coaching tool utilizes one or more facilitators/coaches to interact with the language learner to learn the non-native language, and the one or more facilitators/coaches use the speech recognition tool to provide real-time assessment of the language learner's progress.

2. The language learning platform of claim 1, wherein the language learner accesses the video repository through an authentication process.

3. The language learning platform of claim 2, wherein the language learner accesses the coaching tool through the same authentication process or a different authentication process.

4. The language learning platform of claim 1, wherein the interactive videos comprise integrated speech practice activities.

5. The language learning platform of claim 4, wherein the speech recognition engine assesses performance of the language learner as the language learner progresses through the integrated speech practice activities.

6. The language learning platform of claim 1, wherein the user interface actively manages one or more audio input devices that the language learner uses to perform the integrated speech practice activities.

7. The language learning platform of claim 1, wherein the coaching tool comprises a live lecture tool for broadcasting live lecture sessions accessible to the language learner.

8. The language learning platform of claim 7, wherein the live lecture tool provides interactive speech practice activities during the live lecture sessions, and the speech engine uses the interactive speech practice activities to provide real-time assessment of the language learner's progress during the live lecture sessions.

9. The language learning platform of claim 1, wherein the coaching tool comprises a group session tool for providing one or more live group sessions where the one or more facilitators/coaches work with a plurality of language learners.

10. The language learning platform of claim 9, wherein the group session tool is configured to allow the language learners to practice pronunciation using interactive speech practice activities during the one or more group sessions, and the speech engine uses the interactive speech practice activities to provide real-time assessment of the language learner's progress during the one or more group sessions.

11. The language learning platform of claim 1, wherein the coaching tool comprises a personalized coaching tool for providing a live personalized session where the one or more facilitator/coach work with a single language learner.

12. The language learning platform of claim 11, wherein the personalized coaching tool is configured to allow the language learners to practice pronunciation using interactive speech practice activities during the live personalize session, and the speech engine uses the interactive speech practice activities to provide real-time assessment of the language learner's progress during the live personalized session.

13. A method of learning a new language using a language platform comprising:
providing, using one or more computing device processors, a user interface;
incorporating, using the one or more computing device processors, a speech recognition engine in the user interface;
storing, using the one or more computing device processors, and uploading a plurality of interactive videos to assist a language learner in learning a non-native language;
performing, using the one or more computing device processors, a plurality of challenges by the language learner by leveraging each of the interactive videos;
determining, using the one or more computing device processors, whether the language learner is successful in performing at least one of the challenges;
allowing, using the one or more computing device processors, the language learner access to one or more lectures, one or more group sessions, or personalized coaching through the user interface to assist the language learner in learning the non-native language;
implementing, using the one or more computing device processors, interactions between the language learner and one or more facilitators/coaches to assist the language learner in learning the non-native language via the user interface; and
providing, using the one or more computing device processors, real-time assessment of the language learner's progress in learning the non-native language.

14. The method of claim 13, wherein allowing the language learner access to the one or more lectures, the one or more group sessions, or the personalized coaching comprises broadcasting live lecture sessions accessible to the language learner.

15. The method of claim 14, wherein providing real-time assessment of the language learner's progress comprises providing interactive speech practice activities during the live lecture sessions, and using the interactive speech practice activities to provide real-time assessment of the language learner's progress during the live lecture sessions.

16. The method of claim 13, wherein allowing the language learner access to the one or more lectures, the one or more group sessions, or the personalized coaching comprises providing one or more live group sessions where the one or more facilitators/coaches work with a plurality of language learners.

17. The method of claim 16, wherein providing real-time assessment of the language learner's progress comprises practicing pronunciation using interactive speech practice activities during the one or more group sessions, and using the interactive speech practice activities to provide real-time assessment of the language learner's progress during the one or more group sessions.

18. The language learning platform of claim 13, wherein allowing the language learner access to the one or more lectures, the one or more group sessions, or the personalized coaching comprises providing a live personalized session where the one or more facilitators/coaches work with a single language learner.

19. The language learning platform of claim 18, wherein providing real-time assessment of the language learner's progress comprises practicing pronunciation using interactive speech practice activities during the live personalized session, and using the interactive speech practice activities to provide real-time assessment of the language learner's progress during the live personalized session.

20. A method of learning a new language using a language platform comprising:
providing, using one or more computing device processors, a user interface;
incorporating, using the one or more computing device processors, a speech recognition engine in the user interface;
storing, using the one or more computing device processors, and uploading a plurality of interactive videos to assist a language learner in learning a non-native language;
performing, using the one or more computing device processors, a plurality of challenges by the language learner by leveraging each of the interactive videos;
determining, using the one or more computing device processors, whether the language learner is successful in performing at least one of the challenges; and
providing, using the one or more computing device processors, real-time assessment of the language learner's progress in learning the non-native language.
